(19) United States
(12) Patent Application Publication
(10) Pub. No.: US 2015/0072604 A1
(43) Pub. Date: Mar. 12, 2015

(54) ACTIVE AIR FLAP SYSTEM OF VEHICLE

(71) Applicant: HYUNDAI MOTOR COMPANY, SEOUL (KR)

(72) Inventor: Gilsang Yoo, Incheon (KR)

(73) Assignee: HYUNDAI MOTOR COMPANY, SEOUL (KR)

(21) Appl. No.: 14/137,901

(22) Filed: Dec. 20, 2013

(30) Foreign Application Priority Data
Sep. 9, 2013 (KR) 10-2013-0108067

(51) Int. Cl. B60H 1/26

(52) U.S. Cl. CPC B60H 1/26
USPC 454/152

(57) ABSTRACT

An active air flap system for a vehicle includes a duct allowing ambient air to flow into an engine compartment, a motor in the duct to generate driving force and having a hinge shaft configured to transmit the generated driving force, and a flap coupled to the hinge shaft of the motor to regulate a degree of opening and closing of the opening, and released from the state of being coupled to the hinge shaft of the motor when power supply to the motor is cut off, to open the opening. When power is not applied to the motor of the active air flap system due to an abnormal reason, the flap is separated from the motor so as to be prevented from being stuck due to fault of the motor resulting from an abnormal reason or due to a dead battery.

### CROSS-REFERENCE TO RELATED APPLICATION

The present application claims priority of Korean Patent Application Number 10-2013-0108067 filed Sep. 9, 2013, the entire contents of which application is incorporated herein for all purposes by this reference.

### BACKGROUND OF INVENTION

1. Field of Invention

The present invention relates to an active air flap system of a vehicle and, more particularly, to an active air flap system of a vehicle in which a flap is prevented from being stuck due to failure of a motor, or the like, to thus prevent the interior of an engine compartment from overheating.

2. Description of Related Art

In general, a variety of heat exchangers such as a radiator, an intercooler, an evaporator, and a condenser, as well as components for driving a vehicle such as an engine, are provided within an engine compartment of a vehicle.

A heat-exchanging medium such as a refrigerant flows in the components so as to be heat-exchanged with ambient air of the heat exchangers to perform cooling or heat dissipation. Thus, in order to stably operate the variety of heat exchangers within the engine compartment of a vehicle, ambient air is required to be smoothly supplied to the engine compartment.

However, when a vehicle is running at a high speed, a large amount of ambient air is introduced at a high speed, increasing air resistance. Thus, vehicle fuel efficiency (or mileage) is degraded.

In order to address the problem, an active air flap system is used to make a large amount of air flow to the interior of an engine compartment when a vehicle is running at a low speed and make a relatively small amount of air flow to the interior of the engine compartment when the vehicle is running at a high speed, to thus enhance fuel efficiency.

FIG. 1 illustrates a related art active air flap system. As illustrated in FIG. 1, the active air flap system may be installed in a front end module of a vehicle and may include a duct 10 having an opening 12, a motor 20 installed in a central portion of the duct 10, and a flap 30 coupled to the motor 20 through a hinge.

The flap 130 is regulated in a rotation angle according to driving of the motor 20, so when a vehicle is running at a low speed, the flap 130 opens the opening 12 to be large, and when the vehicle is running at a high speed, the flap 130 opens the opening 12 to be small.

In the related art active air flap system, however, since the motor 20 and the hinge are integrally coupled, when the motor 20 has an error due to an abnormal reason or when a battery supplying power to the motor 20 is dead, the flap 30 is stuck and not operated.

When the flap 30 is stuck and not operated, ambient air cannot flow into the engine compartment of the vehicle. Thus, an internal temperature of the engine compartment is increased to prevent the variety of heat exchangers provided within the engine compartment from operating normally.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an active air flap system having a novel structure having advantages of preventing an internal temperature of an engine compartment from being increased when a vehicle is running, by preventing a flap from being stuck to a motor.

Various aspects of the present invention provide for an active air flap system of a vehicle, including: a duct having an opening allowing ambient air to be introduced to the interior of an engine compartment of the vehicle; a motor provided in the duct, configure to generate driving force according to whether power is applied, and having a hinge shaft configured to transmit the generated driving force; and a flap coupled to the hinge shaft of the motor when power is applied to the motor, to regulate a degree of opening and closing of the opening by the driving force from the motor, and released from the state of being coupled to the hinge shaft of the motor when power supply to the motor is cut off, to open the opening.

The hinge shaft of the motor may be configured as an electromagnet to generate magnetic force according to whether power is applied thereto, and a bonding plate made of a metal may be provided in the flap to allow the flap to be selectively coupled to the hinge shaft according to magnetic force generated by the hinge shaft.

The flap may include: a fixed frame provided in the duct and having an insertion space formed therein; a moving frame selectively inserted into the insertion space of the fixed frame; a bonding plate made of a metal and provided in a surface of the moving frame facing the hinge shaft of the motor; and a main spring provided between the fixed frame and the moving frame and providing elastic force in a direction in which the moving frame is inserted into the insertion space of the fixed frame.

The moving frame may include: a main body having an insertion groove formed in at least one side thereof; a lateral body movably provided in the insertion groove; and a lateral spring provided between the main body and the lateral body and providing elastic force in a direction in which the lateral body is released from the insertion groove, wherein when the moving frame is inserted into the fixed frame, the lateral body is inserted into the insertion groove.

A sloped portion may be formed in a lateral surface of the lateral body facing the fixed frame.

The active air flap system may further include: a fixing unit provided between the fixed frame and the moving frame to prevent the moving frame from being released, when the moving frame is inserted into the insertion space of the fixed frame.

The fixing unit may include: a fixing hole formed in the moving frame; a hook provided of the fixed frame and inserted into the fixing hole when the moving frame is inserted into the insertion space of the fixed frame; and an elastic member providing elastic force in a direction in which the hook is inserted into the fixing hole.

The hook may be rotatably hinge-coupled to the fixed frame, and the elastic member may be a torsion spring provided in a portion in which the fixed frame and the hook are hinge-coupled.

The moving frame may be classified into a plurality of moving frames each having an insertion space formed therein, and each of the moving frames may be inserted into an insertion space of a moving frame that neighbors in a direction in which each of the moving frames is separated from the motor or the fixed frame.

Each of the moving frames may include: a main body inserted into the fixed frame or a neighbor moving frame and having an insertion groove formed in at least one side thereof; a lateral body inserted into the insertion groove and moving up and down; and a lateral spring provided between the main body and the lateral body and providing elastic force in a direction in which the lateral body is released from the insertion groove, wherein when the moving frame is inserted into the fixed frame, the lateral body is inserted into the insertion groove.

The active air flap system may further include: a fixing unit provided between the fixed frame and a moving frame closest to the motor in order to prevent the moving frame from being released when each moving frame is inserted into an insertion space of a rear neighbor frame or the fixed frame.

The fixing unit may include: a fixing hole formed in the moving frame closest to the motor; a hook provided in the fixed frame and inserted into the fixing hole when a forefront moving frame is inserted into the insertion space of the fixed frame; and an elastic member providing elastic force in a direction in which the hook is inserted into the fixing hole.

The hook may be rotatably hinge-coupled to the fixed frame, and the elastic member may be a torsion spring provided in a portion in which the fixed frame and the hook are hinge-coupled.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a plan view illustrating a configuration of the related art active air flap system.

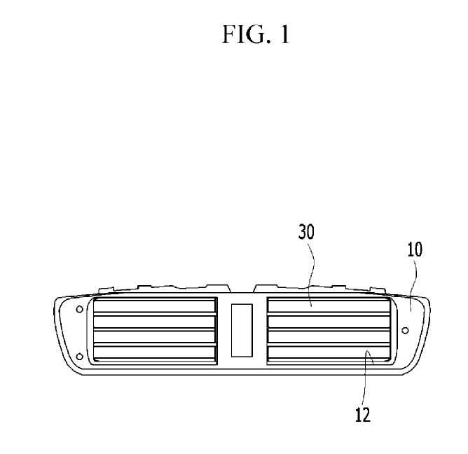

FIG. 2 is a plan view illustrating a configuration of a motor and a flap of the related art active air flap system.

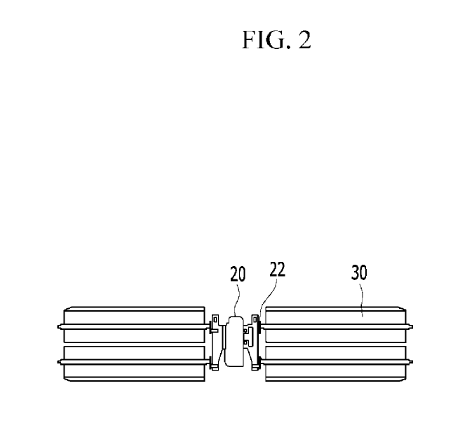

FIG. 3(a) and FIG. 3(b) are plan views illustrating a configuration of an exemplary active air flap system according to the present invention.

FIG. 4 is a plan view illustrating a coupling relationship between a motor and a flap of an exemplary active air flap system according to the present invention.

FIG. 5 is a perspective view illustrating an exemplary configuration of a second main body according to the present invention.

FIG. 6 is a perspective view illustrating an exemplary configuration of a second lateral body and second lateral springs according to the present invention.

FIG. 7 is a perspective view illustrating an exemplary configuration of a first main body according to the present invention.

FIG. 8 is a perspective view illustrating an exemplary configuration of a first lateral body and first lateral springs according to the present invention.

FIG. 9 is a perspective view illustrating an exemplary configuration of a fixed frame according to the present invention.

FIG. 10 is a plan view illustrating an exemplary configuration of a hook according to the present invention.

FIG. 11 is a view illustrating operational states (a) to (d) of an exemplary active air flap system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

To clarify the present invention, portions irrespective of description are limited and like numbers refer to like elements throughout the specification.

Also, in the drawings, sizes and thickness of components are arbitrarily shown for the description purposes, so the present invention is not limited to the illustrations of the drawings and thicknesses are exaggerated to clearly express various parts and regions.

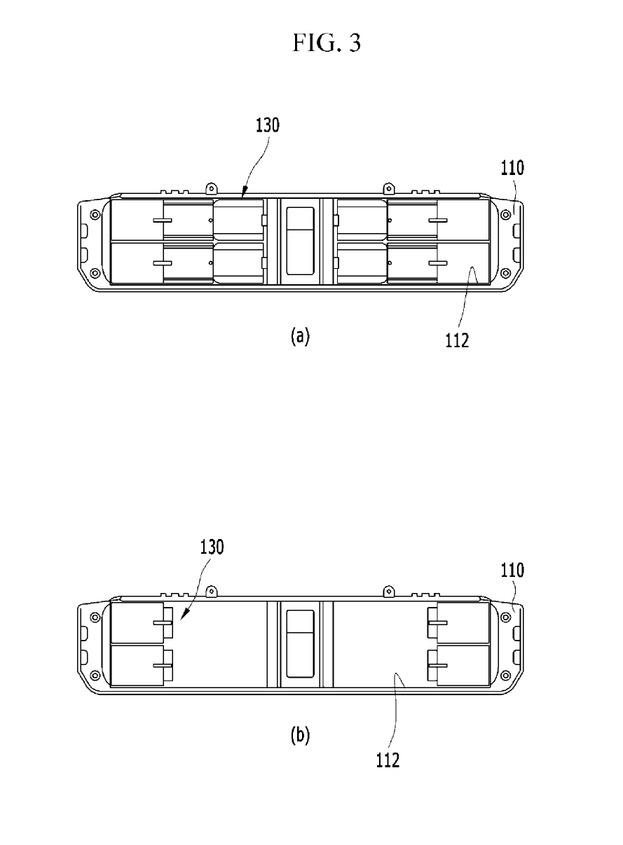

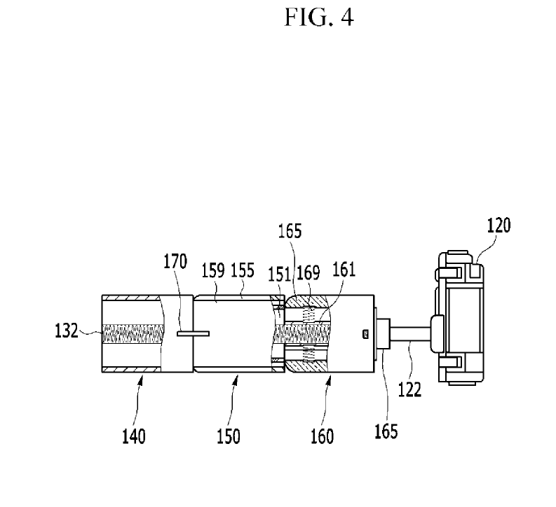

FIG. 3 is a plan view illustrating a configuration of an active air flap system according to various embodiments of the present invention. FIG. 4 is a plan view illustrating a coupling relationship between a motor and a flap of the active air flap system according to various embodiments of the present invention.

As illustrated in FIGS. 3 and 4, the active air flap system according to various embodiments of the present invention includes a motor 120 installed in a duct 110 installed in a front end module of a vehicle, and a flap 130 coupled to both sides of the motor 120 to selectively open and close an opening 112 of the duct 110.

The motor 120, which generates driving force (or power) according to whether power is applied, is connected to the flap 130 through a hinge shaft 122. Here, the hinge shaft 122 provided in the motor 120 is configured as an electromagnet. Thus, when power is supplied to the motor 120, magnetic force is generated from the hinge shaft 122.

The flap 130 is coupled to the hinge shaft 122 of the motor 120, and a rotation angle of the flap 130 is regulated by driving force from the motor 120 to regulate an amount of opening and closing of the opening 112 formed in the duct 110. Namely, when a vehicle is running at a low speed, the rotation angle of the flap 130 is increased to open the opening 112 wide. When the vehicle is running at a high speed, the rotation angle of the flap 130 is reduced to open the opening 112 a little.

When power is applied to the motor 120, the flap 130 of the active air flap system according to various embodiments of the present invention is maintained in a state of being coupled to the hinge shaft 122 of the motor 120. However, when power is not applied to the motor 120, the flap 130 is released from the state of being coupled to the hinge shaft 122 of the motor 120 to open the opening 112 of the duct 110.

In detail, the flap 130 includes a fixed frame 140 provided in the duct 110 and having an insertion space formed therein, moving frames 150 and 160 selectively inserted into the insertion space of the fixed frame 140, an bonding plate 165 made of metal and provided in the side facing the hinge shaft 122 of the motor 120, and a main spring 132 provided between the fixed frame 140 and the moving frames 150 and 160 to provide elastic force in a direction in which the moving frames 150 and 160 are inserted into the insertion space of the fixed frame 140.

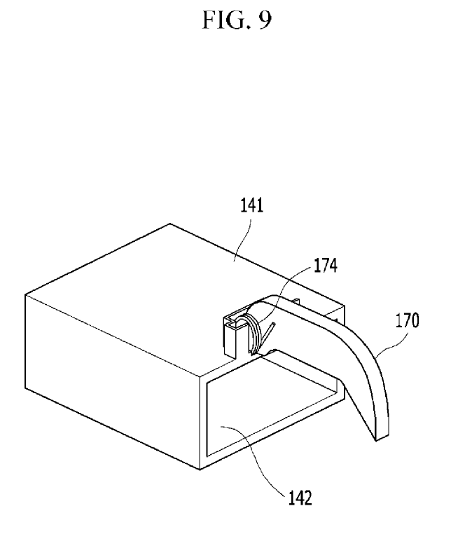

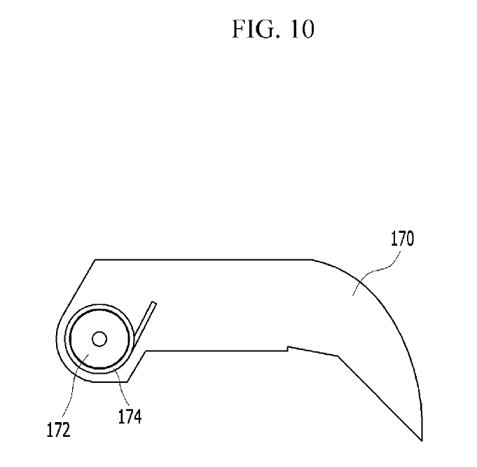

FIG. 9 is a perspective view illustrating a configuration of the fixed frame 140 according to various embodiments of the present invention. FIG. 10 is a perspective view illustrating a configuration of a hook 170 according to various embodiments of the present invention.

As illustrated in the drawings, the fixed frame 140 has a shape of a square block having an insertion space 142 formed therein. The moving frames 150 and 160 are inserted into the insertion space 142, reducing an overall length of the flap 130.

The hook 170 is provided in the fixed frame 140 in order to fix the moving frame when the moving frame is inserted into the insertion space 142. When the moving frame is inserted into the insertion space 142 of the fixed frame 140, the hook 170 is inserted into a fixing hole 164 formed in the moving frame to prevent the moving frame from being released from the insertion space.

The hook 170 is hinge-coupled to an upper portion of the fixed frame 140 and rotatably installed. Here, a torsion spring is installed in the hinge-coupled portion. The torsion spring provides elastic force in a direction in which the hook 170 is inserted into the fixing hole 164 (in the clockwise direction on the basis of FIG. 10).

The moving frame according to various embodiments of the present invention may be configured as plural. Thus, when a plurality of moving frames are provided, a length by which the moving frames are reduced may be adjusted as necessary.

Hereinafter, an example in which two moving frames are provided will be described.

As illustrated in FIG. 4, the moving frames 150 and 160 include a first moving frame 150 inserted into the insertion space 142 of the fixing frame 142 and having a first insertion space 152 and a second moving frame 160 inserted into the first insertion space 152 of the first moving frame 150.

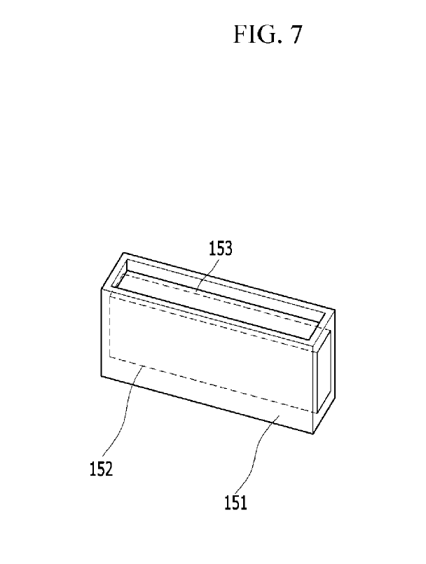

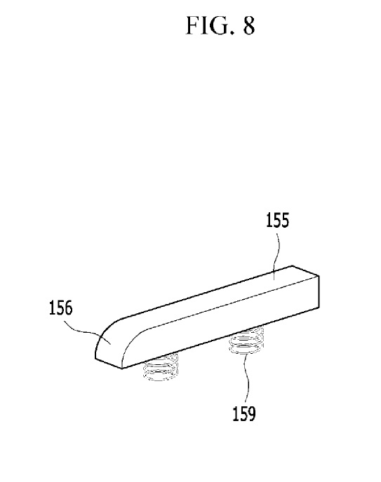

FIG. 7 is a perspective view illustrating a configuration of the first main body 151 according to various embodiments of the present invention. FIG. 8 is a perspective view illustrating a configuration of a first lateral body 155 and first lateral springs according to various embodiments of the present invention.

As illustrated in the drawings, the first moving frame 150 includes the first main body 151 inserted into the insertion space 142 of the fixed frame 140, having a first insertion space 152 formed therein, and having a first insertion groove 153 formed in upper and lower portions thereof, the first lateral body 155 inserted into the first insertion groove 153 and moving up and down, and first lateral springs 159 provided between the first main body 151 and the first lateral body 155 and providing elastic force in a direction in which the first lateral body 155 is released from the first insertion groove 153.

The first main body 151 has a substantially rectangular shape and has the first insertion space 152 formed therein to allow the second moving frame 160 to be inserted therein.

The first lateral body 155 is selectively inserted into the first insertion groove 153 formed in the upper and lower portions of the first main body 151. The first lateral body 155 has a substantially rectangular shape and includes a first sloped portion 156 formed in a portion thereof which is in contact with the fixed frame 140.

When the first moving frame 150 is released from the fixed frame 140, the first lateral body 155 is maintained in a state of being released from the first insertion groove 153 by means of the first lateral springs 159. Namely, when the first moving frame 150 is released from the fixed frame 140, the first lateral body 155 of the first moving frame 150 is maintained in a state of being supported by the fixed frame 140.

However, when the first moving frame 150 is inserted into the fixed frame 140, the first lateral body 155, being pressed by a front end of the fixed frame 140, is inserted into the first insertion groove 153. In other words, when power is not applied to the motor 120 so magnetic force is not generated from the hinge shaft 122, the first moving frame 150 is inserted into the insertion space of the fixed frame 140 by elastic force of the main spring 132. At this time, as the first sloped portion 156 of the first lateral body 155 is pressed by the front end of the fixed frame 140, the first lateral body 155 is moved downwardly. Accordingly, the first lateral body 155 is inserted into the first insertion groove 153, and the first moving frame 150 is inserted into the insertion space of the fixed frame 140.

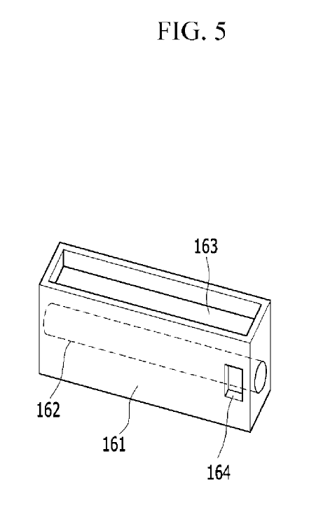

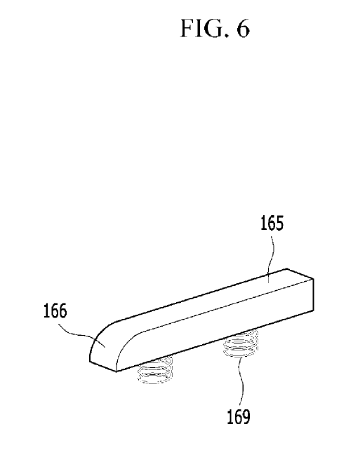

FIG. 5 is a perspective view illustrating a configuration of a second main body 161 according to various embodiments of the present invention. FIG. 6 is a perspective view illustrating a configuration of a second lateral body 165 and second lateral springs 169 according to various embodiments of the present invention.

As illustrated in the drawings, the second main body 161 and the second lateral body 165 have shapes similar to those of the first main body 151 and the first lateral body 155, respectively.

In detail, the second moving frame 160 includes the second main body 161 inserted into the first moving frame 150 and having a second insertion groove 163 formed upper and lower portions thereof, the second lateral body 165 inserted into the second insertion groove 163 and moving up and down, and second lateral springs 169 provided between the second main body 161 and the second lateral body 165 and providing elastic force in a direction in which the second lateral body 165 is released from the second insertion groove 163.

The second main body 161 may have a substantially rectangular shape and may have an insertion space formed therein to allow the main spring 132 to be inserted therein.

The second lateral body 165 is selectively inserted into the second insertion groove 163 formed in the upper and lower portions of the second main body 161. The second lateral body 165 has a substantially rectangular shape and has a second sloped portion 166 formed in a portion thereof which is in contact with the first moving frame 150.

When the second moving frame 160 is released from the first moving frame 150, the second lateral body 165 is maintained in a state of being released from the second insertion groove 163 by means of the second lateral spring 169. Namely, when the second moving frame 160 is released from the first moving frame 150, the second lateral body 165 of the second moving frame 160 is maintained in a state of being supported by the first moving frame 150.

However, when the second moving frame 160 is inserted into the first moving frame 150, the second lateral body 165, being pressed by a front end of the first moving frame 150, is inserted into the second insertion groove 163. In other words, when power is not applied to the motor 120 so magnetic force is not generated from the hinge shaft 122, the second moving frame 160 is inserted into the insertion space of the first moving frame 150 by elastic force of the main spring 132. At this time, as the second sloped portion 166 of the second lateral body 165 is pressed by the front end of the first moving frame 150, the second lateral body 165 is moved downwardly. Accordingly, the second lateral body 165 is inserted into the second insertion groove 163, and the second moving frame 160 is inserted into the insertion space of the first moving frame 150.

The bonding plate 165 made of a metal is provided in a surface of the second moving frame 160 facing the hinge shaft 122 of the motor 120. The bonding plate 165 is selectively coupled to the hinge shaft 122 of the motor 120. Namely, when power is applied to the motor 120, magnetic force is generated from the hinge shaft 122 to attract the bonding plate 165 to allow the hinge shaft 122 of the motor 120 and the flap 130 to be coupled. Accordingly, driving force from the motor 120 is transmitted to the flap 130.

However, when power supply to the motor 120 is cut off, magnetic force is not generated from the hinge shaft 122. Thus, the flap 130 is released from the motor 120.

Hereinafter, an operation of the active air flap system according to various embodiments of the present invention will be described.

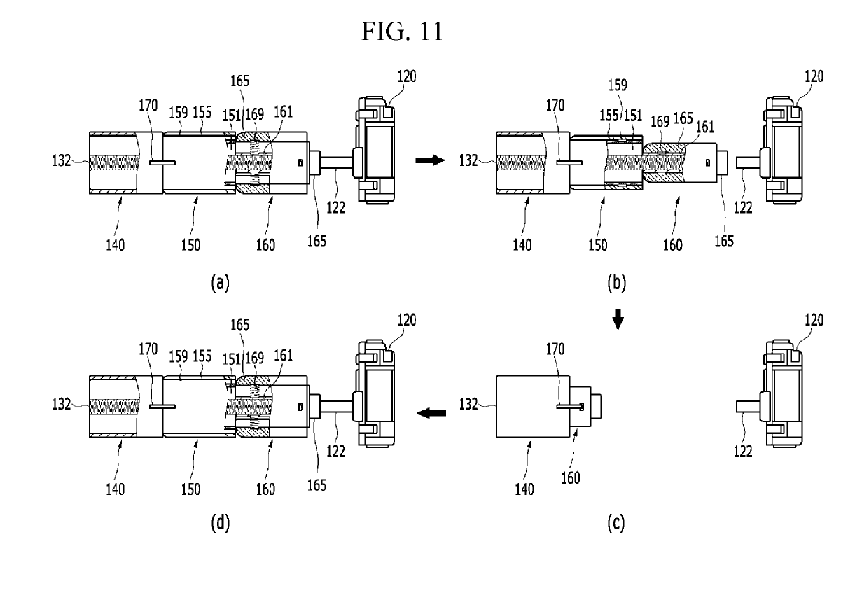

FIG. 11 is a view illustrating an operational state of the active air flap system according to various embodiments of the present invention.

As illustrated in FIG. 11(a), when power is applied to the motor 120, magnetic force is generated from the hinge shaft 122, of the motor 120, configured as an electromagnet. Thus, the bonding plate 165 provided in the second moving frame 160 is attracted to allow the flap 130 to be coupled to the hinge shaft 122 of the motor 120. The motor 120 operates upon receiving power from a battery of the vehicle.

Thus, when the hinge shaft 122 of the motor 120 rotates, the flap 130 is rotated according to frictional contact of the hinge shaft 122 and the bonding plate 165.

Thereafter, as illustrated in FIG. 11(b), when power is not supplied to the motor 120 due to an abnormal reason or when power is not supplied to the motor 120 because the battery is dead, magnetic force is not generated from the hinge shaft 122, of the motor 120, configured as an electromagnet. Thus, the coupling of the hinge shaft 122 of the motor 120 and the bonding plate 165 provided in the second moving frame 160 is released.

Thereafter, as illustrated in FIG. 11(c), the first moving frame 150 is inserted into the insertion space of the fixed frame 140 due to elastic force of the main spring 132, and the second moving frame 160 is sequentially inserted into the insertion space of the first moving frame 150.

When the second moving frame 160 is inserted into the first moving frame 150 and the first moving frame 150 is inserted into the fixed frame 140, the hook 170 provided in the fixed frame 140 is inserted into the fixing hole 164 of the second moving frame 160. Thus, the flap 130 may be stably maintained in a reduced state.

In this manner, as the overall length of the flap 130 is reduced, it is completely released from the hinge shaft 122 of the motor 120. Also, as the overall length of the flap 130 is reduced, the opening 122 of the duct 110 is opened. Accordingly, ambient air may be introduced into the interior of the engine compartment even while the vehicle is running, the engine compartment can be prevented from overheating.

Finally, as illustrated in FIG. 11(d), when the motor 120 is repaired or the battery is exchanged so power is normally supplied to the motor 120, the hook 170 provided in the fixed frame 140 is released from the fixing hole 165 of the second moving frame 160. When power is supplied to the motor 120, the hinge shaft of the motor 120 generates magnetic force, and thus, the bonding plate 165 provided in the second moving frame 160 is coupled to the hinge shaft. Thus, the flap 130 is restored into its original state and the driving force of the motor 120 may be transmitted to the flap 130.

So far, the active air flap system according to various embodiments of the present invention has been described. In various embodiments of the present invention, the case in which the flap 130 has two moving frames has been described. However, the present inventive concept is not necessarily limited thereto and only a single moving may be provided or three or more moving frames may be provided, as necessary.

According to various embodiments of the present invention described above, when power is not applied to the motor of the active air flap system due to an abnormal reason, the flap is separated from the motor so as to be prevented from being stuck due to fault of the motor resulting from an abnormal reason or due to a dead battery.

In addition, since the flap is prevented from being stuck, although power is not applied to the motor, ambient air is introduced to the interior of the engine compartment of a vehicle, whereby an internal temperature of the engine compartment is prevented from being increased while the vehicle is running.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An active air flap system of a vehicle, comprising:
a duct having an opening allowing ambient air into an interior of an engine compartment of the vehicle;
a motor provided in the duct configured to generate driving force and having a hinge shaft configured to transmit the generated driving force; and
a flap coupled to the hinge shaft of the motor to regulate a degree of opening and closing of the opening by the driving force from the motor when power is applied to the motor, and released from the hinge shaft of the motor to open the opening when power supply to the motor is cut off.

2. The active air flap system of claim 1, wherein:
the hinge shaft of the motor is an electromagnet to generate magnetic force according to whether power is applied thereto; and
a bonding plate made of a metal is provided in the flap to allow the flap to be selectively coupled to the hinge shaft according to magnetic force generated by the hinge shaft.

3. The active air flap system of claim 2, wherein the flap comprises:
a fixed frame provided in the duct and having an insertion space formed therein;
a moving frame selectively inserted into the insertion space of the fixed frame;
a bonding plate made of a metal and provided in a surface of the moving frame facing the hinge shaft of the motor; and
a main spring provided between the fixed frame and the moving frame and providing elastic force in a direction in which the moving frame is inserted into the insertion space of the fixed frame.

4. The active air flap system of claim 3, wherein the moving frame comprises:
a main body formed an insertion groove;
a lateral body movably provided in the insertion groove; and
a lateral spring provided between the main body and the lateral body and providing elastic force in a direction in which the lateral body is released from the insertion groove,
wherein when the moving frame is inserted into the fixed frame, the lateral body is inserted into the insertion groove.

5. The active air flap system of claim 4, wherein a sloped portion is formed in a lateral surface of the lateral body facing the fixed frame.

6. The active air flap system of claim 3, further comprising:
a fixing unit provided between the fixed frame and the moving frame to prevent the moving frame from being released, when the moving frame is inserted into the insertion space of the fixed frame.

7. The active air flap system of claim 6, wherein the fixing unit comprises:
a fixing hole formed in the moving frame;
a hook provided in the fixed frame and inserted into the fixing hole when the moving frame is inserted into the insertion space of the fixed frame; and
an elastic member providing elastic force in a direction in which the hook is inserted into the fixing hole.

8. The active air flap system of claim 7, wherein:
the hook is rotatably hinge-coupled to the fixed frame; and
the elastic member is a torsion spring provided in a portion in which the fixed frame and the hook are hinge-coupled.

9. The active air flap system of claim 3, wherein:
the moving frame is classified into a plurality of moving frames each having an insertion space formed therein; and
each of the moving frames is inserted into an insertion space of a moving frame that neighbors in a direction in which each of the moving frames is separated from the motor or the fixed frame.

10. The active air flap system of claim 8, wherein each of the moving frames comprises:
a main body inserted into the fixed frame or a neighbor moving frame and having an insertion groove formed in at least one side thereof;
a lateral body inserted into the insertion groove and moving up and down; and
a lateral spring provided between the main body and the lateral body and providing elastic force in a direction in which the lateral body is released from the insertion groove,
wherein when the moving frame is inserted into the fixed frame, the lateral body is inserted into the insertion groove.

11. The active air flap system of claim 10, further comprising:
a fixing unit provided between the fixed frame and a moving frame closest to the motor in order to prevent the moving frame from being released when each moving frame is inserted into an insertion space of a rear neighbor frame or the fixed frame.

12. The active air flap system of claim 11, wherein the fixing unit comprises:
a fixing hole formed in the moving frame closest to the motor;
a hook provided in the fixed frame and inserted into the fixing hole when a forefront moving frame is inserted into the insertion space of the fixed frame; and
an elastic member providing elastic force in a direction in which the hook is inserted into the fixing hole.

13. The active air flap system of claim 12, wherein:
the hook is rotatably hinge-coupled to the fixed frame; and
the elastic member is a torsion spring provided in a portion in which the fixed frame and the hook are hinge-coupled.
